(19) United States
(12) Patent Application Publication
(10) Pub. No.: US 2024/0406747 A1
(43) Pub. Date: Dec. 5, 2024

(54) METHODS AND SYSTEMS FOR SHARING A SPECTRUM

(71) Applicant: HUAWEI TECHNOLOGIES CO., LTD., Shenzhen (CN)

(72) Inventors: Liqing ZHANG, Kanata (CA); Hao TANG, Kanata (CA); Jianglei MA, Kanata (CA)

(21) Appl. No.: 18/806,981

(22) Filed: Aug. 16, 2024

Related U.S. Application Data
(63) Continuation of application No. PCT/CN2022/076530, filed on Feb. 16, 2022.

(51) Int. Cl. H04W 16/14; H04L 43/16; H04W 74/0808

(52) U.S. Cl. CPC H04W 16/14; H04L 43/16; H04W 74/0808

(57) ABSTRACT

Methods and systems for sharing a spectrum are described. In some examples, signal energy is determined in a channel of the spectrum by the access node. The channel is one of at least two channels including a first channel and a second channel. The first channel is associated with a first energy detection threshold (EDT), the second channel is associated with a second EDT that is different from the first EDT. A signal belonging to a traffic type is transmitted over the channel of the spectrum in response to the determined signal energy satisfying a criteria in related to the first EDT or the second EDT.

### CROSS-REFERENCE TO RELATED APPLICATION

This application is a continuation of International Patent Application No. PCT/CN2022/076530, filed Feb. 16, 2022, the entirety of which is hereby incorporated by reference.

### TECHNICAL FIELD

The present disclosure generally relates to spectrum sensing, in particular, to methods and systems for sharing a spectrum.

### BACKGROUND

Spectrum sensing is a technique for enabling sharing of a spectrum between different service operators or providers based on measuring a detected signal energy of a channel in a shared spectrum. The presence or absence of traffic in the channel may then be determined by comparing the detected signal energy with an energy detection threshold. Spectrum sensing supports spectrum reuse or spectrum sharing, such as to allow secondary networks or secondary users (SUs) to communicate over a spectrum allocated to the primary users (PUs) when the spectrum is not fully utilized.

In this way, a plurality of networks or users may be able to access channels in a shared spectrum without time and/or frequency resources being overlapped. The plurality of networks or users may provide transmissions associated with different traffic types over the channels. However, different traffic types may have different requirements for channel quality.

Therefore, it would be useful to provide a solution for improved spectrum sharing.

### SUMMARY

The present disclosure describes an example method to provide differentiated channels where transmissions associated with different kinds of traffic types are performed. Each channel disclosed herein may comprise one or more resource blocks in frequency domain, such as entire or part of a transmission/system bandwidth in a frequency band over a spectrum. Such a solution may help to ensure a quality of service (QOS) of a first traffic type (e.g., low latency and/or ultra-reliability required) to be high over a first channel that is configured for the first traffic type.

In some embodiments, two or more channel types over a spectrum are defined such that each channel type is associated with a different respective energy detection threshold (EDT). That is, a different respective channel type corresponds to a respective EDT. Thus, an access node may be allowed conditionally to access the different respective channel type to transmit a certain traffic type by configuration or indication. As a different respective traffic type may have a different QoS (e.g., interference level) requirement, different channel types of the spectrum may be allocated for and accessed by the different respective traffic types to ensure a respective QoS of the corresponding traffic type. For example, a traffic type (e.g., the first traffic type) with higher QoS requirement may be configured to be associated with a less interference level. Thus, a channel type with higher quality may be accessed to transmit the traffic type if interference levels in the channel type are less than a threshold which may be able to keep a lower interference condition in support of the traffic type.

In some embodiments, the spectrum includes at least a first and second channel that are configured to support the certain traffic type. For example, the first channel of the spectrum may be configured to support the first traffic type, and the second channel of the spectrum may be configured to support the second traffic type. The first channel may have a channel type that is different than that of the second channel. A first EDT and a second EDT are also disclosed, where the first EDT is associated with the first channel or/and the first traffic type, and the second EDT is associated with the second channel or/and the second traffic type. The first EDT is lower than the second EDT, such that the first EDT is designed to ensure less signal interference in an accessed channel, as disclosed herein. The two EDTs help to differentiate the quality of channels over the spectrum, which may provide the technical advantage that the two traffic types can each access a respective channel that is suitable to the channel quality requirements of each traffic type.

In order to ensure a signal belonging to the first traffic type (e.g., low latency and/or ultra-reliability required) is transmitted with a high QoS, energy is detected in the first channel of the spectrum. If the detected energy in the first channel is less than or equal to the first EDT, it means that the first channel is considered to be idle and can be accessed to transmit the signal. If the detected energy in the first channel is greater than the first EDT, it means that the first channel is considered to be busy.

In some embodiments, by a configuration, cross-channel access may enable a signal of the first traffic type to be transmitted over the second channel in the event that the first channel is busy. In that case, the first EDT is used as a threshold for accessing the second channel, which may help to ensure the QoS of the first traffic type even though the signal is transmitted over the second channel. As the second channel of the spectrum can be used for the transmission of the signal associated with the first traffic type, while the first channel is busy, this provides the technical advantage that efficiency of sharing spectrum may be improved.

In the configuration, when the second channel is attempted to be accessed to transmit a second signal belonging to the second traffic type (e.g., lower priority than the first traffic type), access of the second channel to transmit the second signal may first compare a detected energy in the second channel with the first EDT and/or the second EDT. If the detected energy in the second channel is less than or equal to the first EDT (rather than the second EDT), the second channel is accessed to transmit the second signal. If the detected energy in the second channel is greater than the second EDT, attempt to access the second channel is denied. If the detected energy in the second channel is between the first EDT and the second EDT, it is determined whether higher priority traffic type(s) (e.g., the first traffic type) is occupying the second channel, which may enable the transmission of the second signal over the second channel to only cause limited interference to higher priority traffic type(s) present in the second channel. In some examples, the at least one first traffic type present in the second channel can be detected or identified, for example, by a respective demodulation reference signal (DMRS) that is associated with each of the at least one first traffic type. In the case where the at least one first traffic type present is identified in the second channel, the transmission of the second signal over the second channel is denied. This provides the technical advantage that the QoS of higher priority traffic type may be ensured even when cross-channel access is used.

In some embodiments, a traffic type may be pre-configured or assigned to be transmitted over any types of channels of the spectrum as long as an interference level in the channel meets a criteria of transmitting the traffic type.

According to some example aspects, the present disclosure describes a method for sharing a spectrum between two or more access nodes. The method comprises at an access node: determining signal energy in a channel of the spectrum by the access node. The channel is one of at least two channels including a first channel and a second channel. The first channel is associated with a first energy detection threshold (EDT), and the second channel is associated with a second EDT that is different from the first EDT. A signal belonging to a traffic type is transmitted over the channel of the spectrum in response to the determined signal energy satisfying a criteria related to the first EDT or the second EDT.

In any of the preceding aspects/embodiments, the traffic type is one of at least two traffic types including a first traffic type and a second traffic type. The first traffic type has a higher quality of service (QOS) requirement than the second traffic type.

In any of the preceding aspects/embodiments, the first EDT is different from the second EDT in that the first EDT is less than the second EDT.

In any of the preceding aspects/embodiments, determining signal energy in the channel of the spectrum comprises: performing spectrum sensing to detect signal energy in the first channel or the second channel.

In any of the preceding aspects/embodiments, the criteria related to the first EDT or the second EDT comprises the determined signal energy in the first channel being below the first EDT or the determined signal energy in the second channel being below the second EDT.

In any of the preceding aspects/embodiments, the method further comprises determining that the signal belonging to the traffic type is to be transmitted prior to determining signal energy in the channel of the spectrum.

In any of the preceding aspects/embodiments, the method further comprising: transmitting at least one pilot signal along with the signal over the channel of the spectrum, wherein each of the at least one pilot signal indicates or identifies the traffic type of the signal.

In any of the preceding aspects/embodiments, each of the at least one pilot signal is a reference signal or a demodulation reference signal (DMRS), which is pre-defined or preconfigured.

In any of the preceding aspects/embodiments, the method further comprises receiving at least one configuration signal to provide configurations for sharing the spectrum, each configuration signal being received via Radio Resource Control (RRC) signaling, Downlink Control Information (DCI) signaling, or Medium Access Control-Control Element (MAC-CE) signaling.

In any of the preceding aspects/embodiments, determining signal energy in the channel of the spectrum comprises: detecting energy in the first channel; and detecting energy in the second channel in response to the detected energy in the first channel being greater than the first EDT. Transmitting the signal belonging to the traffic type over the channel comprises: transmitting the signal belonging to the traffic type over the second channel in response to the detected energy in the second channel being less than or equal to the first EDT.

In any of the preceding aspects/embodiments, transmitting the signal belonging to the traffic type further comprising: determining a channel occupancy period (COP) based on the traffic type; and transmitting the signal belonging to the traffic type over the channel of the spectrum within the COP.

In any of the preceding aspects/embodiments, the access node is a base station (BS).

In any of the preceding aspects/embodiments, the access node is a user equipment (UE).

According to some example aspects, the present disclosure describes an access node. The access node comprises: a processor in communication with a storage, wherein the processor is configured to execute the instructions to cause the access node to: determine signal energy in a channel of the spectrum by the access node, wherein the channel is one of at least two channels including a first channel and a second channel, the first channel being associated with a first energy detection threshold (EDT), and the second channel being associated with a second EDT that is different from the first EDT; and transmit a signal belonging to a traffic type over the channel of the spectrum in response to the determined signal energy satisfying a criteria related to the first EDT or the second EDT.

In any of the preceding aspects/embodiments, the traffic type is one of at least two traffic types including a first traffic type and a second traffic type, the first traffic type having a higher Quality of Service (QOS) requirement than the second traffic type.

In any of the preceding aspects/embodiments, the first EDT is different from the second EDT in that the first EDT is less than the second EDT.

In any of the preceding aspects/embodiments, the first channel is configured for the first traffic type, and the second channel is configured for the second traffic type.

In any of the preceding aspects/embodiments, the processor is configured to execute the instructions to determine signal energy in the channel of the spectrum by: performing spectrum sensing to detect signal energy in the first channel or the second channel.

In any of the preceding aspects/embodiments, the criteria related to the first EDT or the second EDT comprises the determined signal energy in the first channel being below the first EDT or the determined signal energy in the second channel being below the second EDT.

In any of the preceding aspects/embodiments, the processor is further configured to execute the instructions to: determine that the signal belonging to the traffic type is to be transmitted prior to determining signal energy in the channel of the spectrum.

In any of the preceding aspects/embodiments, the processor is further configured to execute the instructions to transmit at least one pilot signal along with the signal over the channel of the spectrum. Each of the at least one pilot signal indicates the traffic type of the signal.

In any of the preceding aspects/embodiments, each of the at least one pilot signal is a reference signal or a demodulation reference signal (DMRS), which is pre-defined or preconfigured.

In any of the preceding aspects/embodiments, the processor is further configured to execute the instructions to receive at least one configuration signal to provide configurations for sharing the spectrum, each configuration signal being received via Radio Resource Control (RRC) signaling, Downlink Control Information (DCI) signaling, or Medium Access Control-Control Element (MAC-CE) signaling.

In any of the preceding aspects/embodiments, the processor is further configured to execute the instructions to: determine signal energy in the channel of the spectrum by: detecting energy in the first channel; and detecting energy in the second channel in response to the detected energy in the first channel being greater than the first EDT. The processor is configured to execute the instructions to transmit the signal belonging to the traffic type over the channel by: transmitting the signal belonging to the traffic type in response to the detected energy in the second channel being less than or equal to the first EDT.

In any of the preceding aspects/embodiments, the processor is further configured to execute the instructions to transmit the signal belonging to the traffic type by: determining a channel occupancy period (COP) based on the first traffic type; and transmitting the signal belonging to the traffic type over the channel of the spectrum within the COP.

According to some example aspects, the present disclosure describes a non-transitory computer readable medium storing instruction which, when executed by a processor, cause the processor to perform any one of the methods disclosed herein.

### BRIEF DESCRIPTION OF THE DRAWINGS

Reference will now be made, by way of example, to the accompanying drawings which show example embodiments of the present application, and in which:

FIG. 1 is an example telecommunication network in accordance with examples of the present disclosure;

FIG. 2A is an example spectrum that is used for spectrum sharing by the example telecommunication network of FIG. 1;

FIG. 2B is a flowchart illustrating an example method of transmitting a signal belonging to a traffic type over the example spectrum of FIG. 2A;

FIG. 2C is a flowchart illustrating an example of how a first signal belonging to a first traffic type is transmitted over the example spectrum of FIG. 2A;

FIG. 2D is a flowchart illustrating an example of how a second signal belonging to a second traffic type is transmitted over the example spectrum of FIG. 2A;

FIG. 2E is a block diagram illustrating a frame structure in a downlink (DL) direction;

FIG. 2F is a block diagram illustrating a frame structure in an uplink (UL) direction; and

FIG. 3 is a block diagram illustrating an example apparatus suitable for implementing examples disclosed herein.

Similar reference numerals may have been used in different figures to denote similar components.

### DETAILED DESCRIPTION

The following describes example technical solutions of this disclosure with reference to accompanying drawings.

The present disclosure provides methods and systems for sharing a spectrum by at least first and second traffic types. The first and second traffic types each is associated with a different respective channel type, for example including at least first or second channel. The first traffic type has a first priority higher than a second priority of the second traffic type. That means, the first traffic type has a QoS requirement that is higher than that of the second traffic type. For example, the first traffic type may define a first network service that requires wireless communications to be transmitted with higher reliability and lower latency, for example including applications related to ultra-reliable low latency communications (URLLC), such as autonomous driving and electronic smart grid networks. The second traffic type may define a second network service (e.g., internet browsing, file downloading) in which wireless communications can be transmitted with best effort (i.e., not subject to strict reliability or latency requirements). It should be noted that, although first and second traffic types are described in some examples, the present disclosure is not limited to only first and second traffic types. For example, examples of the present disclosure may be adapted to additionally support a third traffic type (which may have an even higher priority than the first traffic type). Transmission regarding the third traffic type will be discussed further below.

In some examples, an access node may provide network services belonging to different kinds of traffic types, and the different kinds of traffic types may be configured to be associated with and access one or more channel types over the spectrum. Accessing each of one or more channel types may be permitted if each channel quality of the one or more channel types satisfies a criteria associated with channel quality estimation. The channel quality estimation including spectrum sensing or energy detection is implemented the access node that has an intention to transmit a signal belonging to a traffic type with a different QoS requirement. For example, a first channel of the spectrum may be configured to support the first traffic type, and a first energy detection threshold (EDT) is applied to correspond to the first channel or the first traffic type. A second channel of the spectrum may be configured to support the second traffic type, and a second EDT is utilized to correspond to the second channel or the second traffic type.

In some applications, due to the fact that transmission powers of downlink (DL) and uplink (UL) transmissions can be different, the first EDTs used for sensing and estimating the first channel for the DL and UL transmissions respectively are different. That is, the first EDT applied for sensing and estimating the first channel for the DL transmissions is different than that applied for the UL transmissions. Likewise, the second EDT utilized for sensing and estimating the second channel for the DL transmissions may be different than that utilized for the UL transmissions.

In some examples, by a configuration, cross-channel access may be permitted, in which a signal belonging to the first traffic type (normally being configured to use the first channel) can be transmitted over the second channel (which is normally configured to carry the second traffic type). The configuration of which channel to carry which specific traffic type may be implemented by configuring a respective identification for each traffic type. In the event that the first channel is busy, energy is detected in the second channel of the spectrum. The detected energy in the second channel is compared with a first EDT (which may represent a maximum acceptable interference level in an accessed channel for a transmission of the first traffic type). The first signal can be transmitted over the second channel as long as the detected energy in the second channel is less than the first EDT, rather than a second EDT (which is greater than the first EDT, and which may represent a maximum acceptable interference level in an accessed channel for a transmission of the second traffic type). Thus, even though the first signal belonging to the first traffic type is transmitted over the second channel that is configured for the second traffic type with lower priority, the QoS of the transmission is ensured because the first EDT (which is stricter than the second EDT) is used to compare the detected energy in the second channel.

If cross-channel access is permitted by a configuration, there is a possibility that the first traffic type (which has higher priority) is transmitted over the second channel. If a signal energy in the second channel is less than the first EDT, rather than the second EDT, the second channel is allowed to be accessed to transmit of the second signal. In order to prevent a transmission of a second signal belonging to a second traffic type from causing interference for the first traffic type in the second channel, the present disclosure describes a procedure for determining whether a traffic type having a priority higher than the second priority exists in the second channel in a case where a detected energy in the second channel is between the first and second EDT. If no traffic type having a priority higher than the second priority is present in the second channel, the second channel can be accessed to transmit the second signal. If the second channel is being accessed by a traffic type having a priority higher than the second priority, transmission of the second signal over the second channel may be denied to avoid causing interferences to the higher priority traffic type present in the second channel.

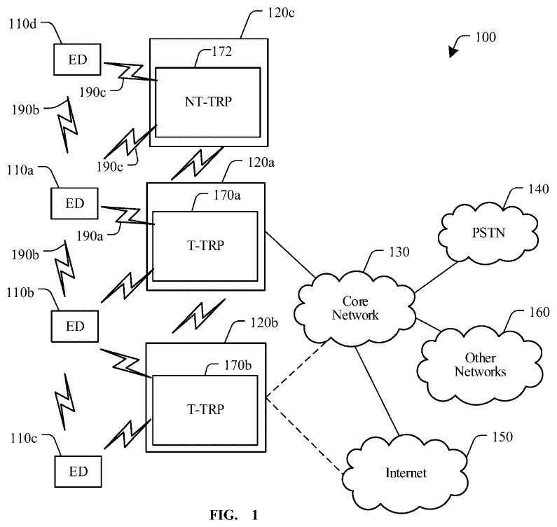

FIG. 1 illustrates an example communication system 100, which may be applied in a next generation (e.g., sixth generation (6G) or later) radio access network, or a legacy (e.g., 5G, 4G, 3G, or 2G) radio access network. As shown in FIG. 1, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes a non-terrestrial node, which may be generically referred to as a non-terrestrial transmit and receive point (NT-TRP) 172.

The communication system 100 may include a terrestrial communication system and/or a non-terrestrial communication system. The communication system 100 may provide a wide range of communication services and applications (such as, internet browsing, file downloading, autonomous driving, electronic smart grid networks etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks. The terrestrial communication system and the non-terrestrial communication system could be considered sub-systems of the communication system 100.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology (RAT) as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). The EDs 110a 110b, and 110c may be multimode devices capable of operation according to multiple radio access technologies, and incorporate multiple transceivers necessary to support such.

In the example of FIG. 1, the communication system 100 may operate by sharing channel resources (e.g., time and/or frequency resources). If channel resource allocation of the spectrum and usage information within the communication system 100 can be exchanged, the spectrum sharing can be performed without any channel resource (e.g., time and/or frequency resources) overlapping. In a scenario where the channel resource allocation of the spectrum and usage information within the communication system 100 is unable to be exchanged (e.g., due to each network node belonging to a different operator), the spectrum sharing can be performed based on a spectrum sensing and accessing scheme. Although the spectrum sharing may lead to any channel resource (e.g., time and/or frequency resources) overlapping, an EDT applied as a criteria to allow for transmissions may enable the interferences caused by the overlapping to be controllable. The spectrum sensing and accessing scheme may be based on a Listen-Before-Talk (LBT) or Listen-While-Talk (LWT) mechanism, such as that used in New Radio-Unlicensed (NR-U) or WiFi networks.

A conventional spectrum sensing technique typically only uses a single EDT to compare with detected energy over a channel of the spectrum to determine whether the channel is busy or idle. Generally, the single EDT is applicable to any shared channel and corresponds to a single one interference level. However, the single EDT (corresponding to the single one interference level) is unable to distinguish between different channels having different channel quality. For example, network services with ultra-reliability and low latency requirements may require higher channel quality with lower interference level, compared with other lower priority applications for which the single one interference level may be sufficient.

The present disclosure provides a spectrum sensing solution herein to ensure QoS of transmissions associated with various traffic types. In particular, examples of the present disclosure enable delivery of a traffic type requiring lower latency and more reliability (compared with another traffic type providing best effort services) with sufficiently high quality. Spectrum expenses and operating costs may be reduced by applying the spectrum sensing solution which will be discussed further below, without degrading the QoS for the various traffic types that may be delivered over the shared spectrum.

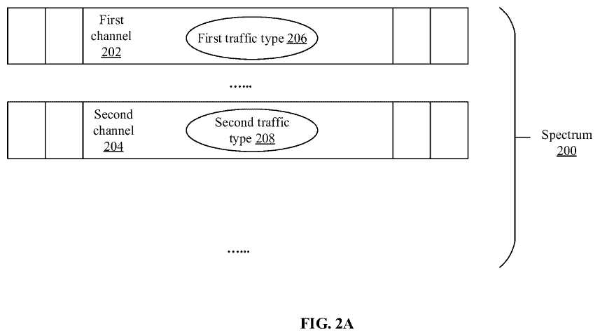

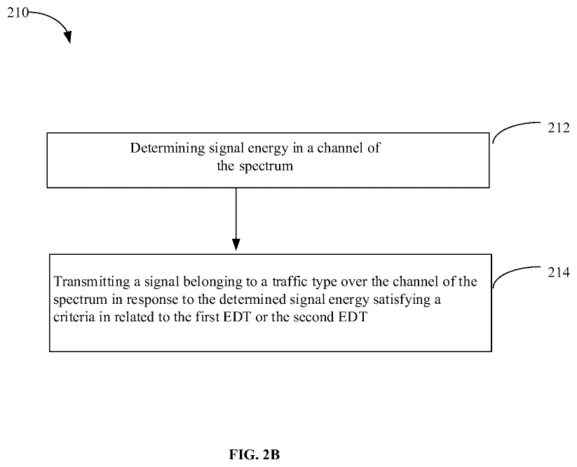

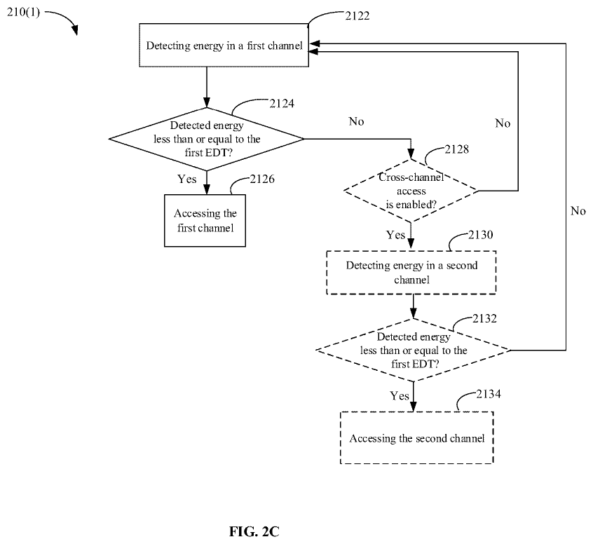

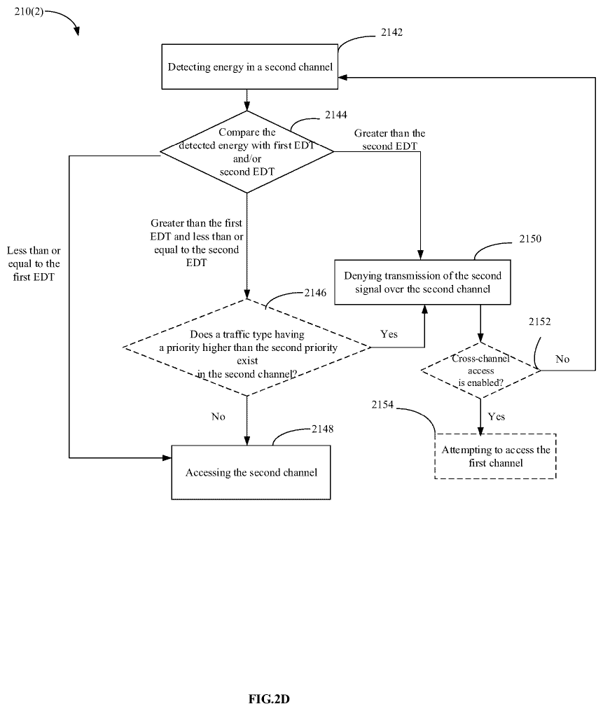

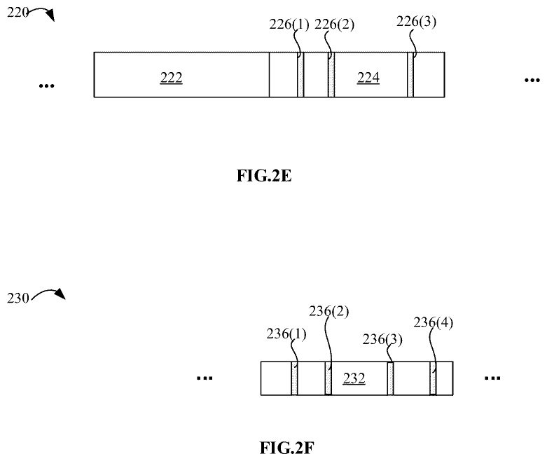

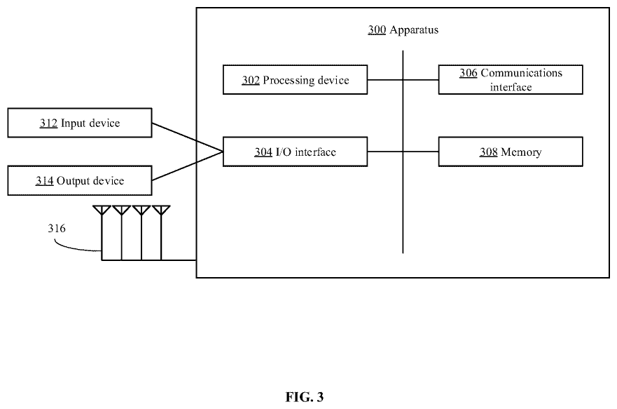

FIG. 2A shows channel assignments or channel resource allocation of a spectrum 200 where signals belonging to at least a first and a second traffic type 206, 208 are transmitted respectively in accordance with examples. The spectrum 200 includes at least a first channel 202 with a first EDT and a second channel 204 with a second EDT. The first channel 202 is used for transmissions associated with the first traffic type 206, and the second channel 204 is used for transmissions associated with the second traffic type 208. The first traffic type 206 has a first priority that is higher than a second priority of the second traffic type 208. In this example, as discussed above, the first traffic type 206 defines the first network service that requires wireless communications to be transmitted with a higher QoS requirement (e.g., higher reliability and lower latency). The first network service may include higher grade applications, such as ultra-reliable low latency communications (URLLC), autonomous driving, or electronic smart grid networks which require shorter latency and/or more reliability. The second traffic type 208 defines the second network service in which wireless communications can be transmitted with a QoS requirement (e.g., best effort) that is relatively lower than the QoS requirement of the first traffic type 206. The “best effort” means that the second network service does not provide any guarantee for whether the wireless communications are successfully transmitted or that the transmissions meet any quality of service. The second network service may include internet browsing or file downloading, for example. In this regard, the first EDT is defined to be less than the second EDT such that the first channel 202 associated with the first EDT may be configured to carry the first traffic type 206, whereas the second channel 204 associated with the second EDT may be configured to carry the second traffic type 208. Thus, transmissions associated with the first channel or the first traffic type are ensured to be performed with lower channel interference, to help avoid poor network performance characteristics (e.g., network delay, packet loss, etc.). Therefore, the first EDT corresponds to the first channel or the first traffic type 206 which requires a lower interference level compared to an interference level that is acceptable for the second channel or the second traffic type 208 corresponding to the second EDT. By way of example, the first EDT may be set to be equal to the second EDT minus an offset (i.e., a positive number, e.g., 5 dB, which may be configurable). In another examples, the two EDTs may defined by adding a different respective offset to a common reference value. For examples, the first EDT is defined by adding a first offset to the common reference value, which is less than a second offset that is added to the common reference value to constitute the second EDT.

FIGS. 2B-2D are flowcharts illustrating an example method 210 of accessing a spectrum (e.g., the spectrum 200) by an access node in accordance with examples disclosed herein. The access node may be a BS from one of the T-TRPs 170a-170b, a UE of any of the EDs 110, or NT-TRP 172 in the example of FIG. 1 among other possibilities. The method 210 comprises steps 212-214. Using the method 210, the access node may perform signal transmissions associated with at least one of the first traffic type 206 or the second traffic type 208.

At step 212, signal energy is determined in a channel of the spectrum. The channel may be the first channel 202 or the second channel 204. The first channel 202 is associated with the first EDT, and the second channel is associated with the second EDT.

At step 214, a signal belonging to a traffic type is transmitted over the channel of the spectrum in response to the determined signal energy satisfying a criteria related to the first EDT or the second EDT. The traffic type may be the first traffic type 206 or second traffic type 208. The signal may be a first signal belonging to the first traffic type 206 or a second signal belonging to the second traffic type 208. In some examples, the criteria in relation to the first EDT or the second EDT may include a criterion that the determined signal energy in the first channel is below (e.g., less than or equal to) the first EDT, or the determined signal energy in the first channel is greater than the first EDT, or the determined signal energy in the second channel is below the second EDT, or the determined signal in the second channel is greater than the second EDT, to determine the channel access availability, which will be discussed further below.

In some examples, the first channel 202 that is associated with the first EDT may be configured or designated to carry the first traffic type 206, and the second channel 204 that is associated with the second EDT may be configured or designated to carry the second traffic type 208. Thus, in this configurations, the first channel 202 may be utilized for transmissions of the first traffic type and the second channel 204 may be utilized for transmission of the second traffic type. Before transmission, an access node with the first traffic type may need to evaluate the first channel by performing a spectrum sensing or signal energy detection (the signal energy detection will be discussed further below) to determine if the first channel is idle. The first channel is considered to be idle if the detected signal energy in the first channel is below (e.g., less than or equal to) the first EDT. If the detected signal energy in the first channel is greater than the first EDT, the first channel is considered to be busy. The access node may transmit at least one signal belong to the first traffic type if the first channel is evaluated to be idle. If the first channel is estimated to be busy, the access node is not allowed for the transmissions and may need to perform further evaluation of the first channel or the second channel of the spectrum. The procedure to transmit the first traffic type over the first channel is also similar to a process for any access node intending to transmit the second traffic type (that is configured to be associated with the second channel). The only differences between transmitting the second traffic type over the second channel and transmission of the first traffic type over the first channel are that the spectrum sensing or signal energy detection is performed in the second channel, and a detection threshold used for comparison is the second EDT. In that case, the second channel is considered to be idle if the detected signal energy in the second channel is below (e.g., less than or equal to) the second EDT. The configurations for associating each traffic type with a respective channel and other transmission parameters may include semi-static configuration (e.g., via Radio Resource Control (RRC) signaling), by dynamic configuration (e.g., by L1/(Downlink Control Information) DCI signaling), and/or via Medium Access Control-Control Element (MAC-CE) signaling.

In some examples, in order to utilize resources of the spectrum efficiently, when designated channels for a certain traffic type is busy, an access node may attempt to access other channels to transmit the certain traffic type if the access node is configured for cross-channel access. Details of example operations will be discussed further with reference to FIGS. 2C-2D.

In the case where the first channel 202 is initially designated for the first traffic type 206, which is configured to allow for access to the second channel (i.e., cross-channel configuration), the method 210 may be a method 210(1), which is illustrated in FIG. 2C including steps 2122-2134 in greater detail.

As presented in FIG. 2C, at step 2122, energy detection is performed in the first channel (e.g., the first channel 202). The access node may determine that the first signal to be transmitted belongs to the first traffic type (e.g., the first traffic type 206 that requires a lower interference level). For example, the access node may determine a traffic type or traffic QoS requirements based on network service type or application type (e.g., URLLC, IoT or eMBB service, etc.). Furthermore, because the first channel 202 is initially designated to carry the first traffic type 206 in this case, the access node selects the first channel to perform the energy detection.

In some examples, the step 2122 is performed in a sensing time period, such as in a duration of a symbol (e.g., 9 us or 16 us). The sensing time period could be predefined or configurable. With respect to implementation of the step 2122, a back-off number (denoted as M) is generated based on a contention window (CW) which is randomly selected between values of a minimum CW and a maximum CW. In DL transmissions, the value of CW may be in a range of {15, 63}. In regard to UL transmissions, the value of CW may be in a range of {15, 1023}. The back-off number is used to indicate the number of times to perform the energy detection in the sensing time period.

At step 2124, it is determined whether the detected energy in the first channel 202 is less than or equal to the first EDT. Because the signal belongs to the first traffic type and is to be transmitted in the first channel, the first EDT is used for the energy detection and decision. Therefore, prior to transmitting the first signal belonging to the first traffic type over the first channel 202, the access node first determines whether the first channel is busy or idle by comparing the detected energy in the first channel 202 with the first EDT.

At step 2126, if the detected energy in the first channel is determined to be less than or equal to the first EDT at step 2124, the first channel is accessed to transmit the first signal belonging to the first traffic type. In particular, when the detected energy in the first channel 202 is less than or equal to the first EDT, that means the first channel 202 is idle. Therefore, the quality of the first channel is sufficient or interference in the first channel is low enough for transmission of the first signal belonging to the first traffic type.

With respect to the implementation of the step 2126, if the first channel is determined to be idle, the access node counts down the back-off number M by 1, and continues detecting energy in the first channel in the sensing time period. Once the access node determines that the first channel is idle and the back-off number M equals to 0, the access node then accesses the first channel in a channel occupancy period (COP) to transmit the first signal belonging to the first traffic type. The COP defines a time period during which the access node may perform transmissions in an accessed channel without repeated sensing. Thus, there is no need for repeated sensing during the COP. The COP may be greater or equal to a minimum COP and less than or equal to a maximum COP. The minimum COP and the maximum COP are configurable, such as via semi-static signaling (e.g., RRC signaling).

In some examples, when a hybrid automatic repeat request (HARQ) feedback is negative acknowledgement or not acknowledged (NACK), the CW may be increased, for example being double (less than the maximum CW) as the initially generated CW.

By way of non-limiting example, in one possible configuration, the COP may be configured based on the traffic type. That means, for a transmission of a signal belonging to a given traffic type, the COP will be the same regardless of which channel will be accessed for the transmission. For different traffic types, the corresponding COPs may be different. For example, a transmission belonging to the first traffic type 206 may occupy a channel for a period of time that is different than that for a transmission belonging to the second traffic type 208 over the same channel.

In this example, the access node may be configured to support a cross-channel feature by semi-static configuration (e.g., RRC configuration), by dynamic configuration (e.g., by L1/DCI signaling), and/or via Medium Access Control-Control Element signaling. In that case, returning to step 2124, if it is determined that the detected energy in the first channel is not less than or equal to the first EDT (i.e., the first channel 202 is busy), optional step 2128 is performed. At step 2128, it is determined whether cross-channel access is enabled.

In some examples, the access node may perform the cross-channel access determination after the first channel 202 is determined to be busy for a configured number of tries or a configured time period. That is, if the first channel 202 is determined to be busy, the access node may maintain the back-off number M (i.e., not decreasing by 1), and may continue detecting energy in the first channel until the number of tries or the configured time period expires.

In this example, if the access node is configured to enable cross-channel access, the access node will decide whether the second channel (e.g., the second channel 204) can be used for transmitting the first signal belonging to the first type traffic at optional steps 2130-2132. It is noted that in other examples, the access node may use any other channels (configured to have priorities lower than the first channel) to perform the cross-channel access. In the case where the access node is not enabled for cross-channel access, the access node waits for a second pre-configured time period, and returns to the step 2122 to perform the energy detection in the first channel again.

At step 2130, energy is detected in the second channel in the case where the detected energy in the first channel is greater than the first EDT and the cross-channel access is enabled. With respect to the implementation of energy detection in the second channel, the implementation procedure is similar to the energy detection in the first channel.

At optional step 2132, it is determined whether the detected energy in the second channel 204 is less than or equal to the first EDT. If the detected energy in the second channel 204 is less than or equal to the first EDT, optional step 2134 is performed. If the detected energy in the second channel is greater than first EDT, it means interference level in the second channel is too high for the transmission of the first traffic type 206. Therefore, the access node may wait for a third pre-configured time period, and then return to step 2122 to detect energy in the first channel again.

In some examples, the first pre-configured time period (i.e., the time period that the access node may wait following step 2124 before returning to step 2122), the second pre-configured time period (i.e., the time period that the access node may wait following step 2128 before returning to step 2122), and the third pre-configured time period (i.e., the time period that the access node may wait following step 2132 before returning to step 2122) may be pre-configured by the access node or another network node. Each of the time periods could be any configured time period suitable for the respective implementation.

At optional step 2134, the second channel 204 is accessed in response to the detected energy in the second channel being less than or equal to the first EDT.

Steps 2122-2134 as presented in FIG. 2C details an example of how to transmit the first signal of the first traffic type 206 over the first channel 202 or second channel 204. In the case where step 2122 is performed to detect energy in the first channel and the detected energy in the first channel is less than or equal to the first EDT at step 2124, the first channel is accessed to transmit the first signal belonging to the first traffic type. In the scenario where the first channel is determined to be busy and step 2132 is performed to detect energy in the second channel if the access node is enabled for cross-channel access, the second channel may be accessed to transmit the first signal belonging to the first traffic type if the detected energy in the second channel is less than or equal to the first EDT. In this case, even though the second channel may be used for transmissions belonging to the first traffic type, the detected energy in the second channel is compared with the first EDT, rather than the second EDT. By comparing the detected energy of the second channel to the first EDT, it may be ensured that an interference level in the second channel is low enough such that the first signal belonging to the first traffic type (e.g., URLLC traffic requiring high QoS) is transmitted with sufficient QoS over the second channel. In this way, signals associated with the first traffic type may be transmitted with sufficiently high quality even though the first channel that is configured to carry the first traffic initially is busy and not able to be accessed.

The definition of two different EDTs (corresponding to two different maximum acceptable interference levels) to distinguish between different channels over the shared spectrum may help to improve channel access by transmissions belonging to different traffic types having different priority levels. In particular, the QoS of higher priority traffic may be ensured over the differentiated channels, while managing channel access by lower priority traffic.

Thus, although the second channel 204 may include mixed traffic types (i.e., include both first and second traffic type 206 and 208), the QoS required by the first traffic type can be guaranteed as the detected energy in the second channel is compared with the first EDT, instead of the second EDT in this scenario.

Such a method by a configuration may enable the access node to access two types of channels (e.g., the first and second channel 202, 204) of the spectrum to ensure that services associated with the first traffic type 206 can be provided with sufficiently high quality. This may help to improve efficiency of sharing the spectrum, especially when the types of traffic from different access nodes does not match the configured channel resource allocation (e.g., the number of the first and second channels) over the given spectrum.

In the event that none of the channels over the shared spectrum is available for transmitting the first signal belonging to the first traffic type, the access node may send a notification message to a network node (e.g., the network entity used to establish the network service with the access node) in order to notify the network node that none of channels over the spectrum is available. In a scenario where the access node is a UE and none of the channels over the spectrum is idle after a plurality of spectrum sensing procedures (e.g., the access node is enabled for cross-channel access and both the first channel and the second channel are unavailable after performing the sensing operations as described above), the UE may use a random-access channel (RACH) or a physical uplink control channel (PUCCH) to send the notification message.

With respect to a second signal belonging to a second traffic type (e.g., providing network services having lower priority (lower QoS requirement)) being transmitted over the spectrum, the method 210 may be a method 210 (b), which is present in FIG. 2D in details. In particular, FIG. 2D illustrates an example process by which transmission of a second signal belonging to the second traffic type may be performed in consideration of the possibility of cross-channel access by higher priority traffic.

At step 2142, because the second channel 204 is (initially) designated for the second traffic type 208, the access node performs energy detection in the second channel 204 after it is determined that the second signal to be transmitted belongs to the second traffic type (e.g., providing best-effort service). The determination of the second signal belonging to the second traffic type may be similar to that of the first traffic type as described above.

At step 2144, the detected energy in the second channel 204 is compared with the first EDT and/or second EDT. If the detected energy in the second channel 204 is greater than the second EDT, that means the second channel 204 is too busy (or signal interference level in the second channel 204 is too strong) to allow the transmission of the second signal. If the detected energy in the second channel 204 is greater than the second EDT, step 2150 is performed to deny (or to stop) transmission of the second signal over the second channel 204. When the detected energy in the second channel 204 is less than the first EDT, it means that the second channel 204 is idle enough to provide sufficient quality for the transmission of the second signal, step 2148 is then implemented as illustrated below. Notably, when the detected energy in the second channel 204 is less than the first EDT, this also means that the second channel 204 is sufficient idle that transmission of the second signal would not negatively impact the transmission of any other higher priority traffic already in the second channel 204. When the detected energy is greater than the first EDT and less than or equal to the second EDT, the access node may perform step 2146 in order to determine whether a traffic type having a priority higher than the second priority is currently accessing the second channel 204. This may be performed to ensure that the quality of the second channel 204 is not negatively affected by transmission of lower priority traffic when there is already higher priority traffic in the second channel 204. In some applications where a cross-channel access function is not configured with the access node, the access node may not consider the possibility that there is higher priority traffic (with higher QoS requirements) being transmitted over the second channel. Thus, the access node may skip step 2146 and perform step 2148 to transmit the second signal over the second channel if the detected energy is less than the second EDT.

At step 2146, the access node further determines whether a traffic type having a priority higher than the second priority is occupying the second channel. When it is determined that there is not any traffic type having a priority higher than the second priority in the second channel 204, step 2148 is performed to access the second channel 204 and to transmit the second signal. If a traffic type (e.g., the first traffic type) having a priority higher than the second priority is present in the second channel 204, access to the second channel 204 is denied at step 2150, in order to avoid causing an unacceptable level of interference for the higher priority traffic type (e.g., the first traffic type) in the second channel.

In some examples, a respective pilot signal may be associated with each traffic type in the second channel or associated with transmission of a signal belonging to a traffic type. An example of transmitting at least one pilot signal each identifying a respective traffic type will be discussed further with reference to FIGS. 2E-2F.

If transmission over the second channel 204 is denied at step 2150, step 2152 may be performed to determine whether the access node is configured or enabled with a function of cross-channel access. If the access node is not enabled to cross-channel access, the access node may return back to step 2142 to perform energy detection in the second channel after a pre-configured time period expires. If the access node is enabled to perform cross-channel access, at step 2154, when the access node has determined that the second channel 204 is busy and access is denied, the access node may attempt to access the first channel 202 to transmit the second signal. In this case, even though the second signal belongs to the second traffic type, the access node may attempt to transmit the second signal over the first channel 202 by performing energy detection using the first EDT. If the detected energy in the first channel 202 is less than the first EDT, the access node then transmits the second signal in the first channel 202. Based on reciprocal and mutual interference phenomenon between two access nodes, if one access node senses the interference level from transmissions implemented by the other access node below the first EDT, it means that transmission performed by the access node may cause little or limited interferences to the other access node. Thus, if the access node performing the method 210(2) is one of two access nodes accessing the first channel, if the detected energy in the first channel is below the first EDT, the transmission of the second signal on the first channel 202 may not cause unacceptable negative impacts on other transmissions (e.g., performed by the other access node) present in the first channel 202. In this case, the transmission of the second signal over the first channel 202 can be transparent to the other transmissions (e.g., performed by the other access node) in the first channel 202. Thus, identification of the traffic types of the other transmissions may be omitted or skipped, even though cross-channel access is performed.

Referring to FIGS. 2E and 2F, transmitting the least one pilot signal in frame structures is now discussed with greater details. FIG. 2E demonstrates an example frame structure 220 where the access node receives at least one pilot signal associated with a signal belonging to (or associated with) a traffic type in a DL direction. In the example of FIG. 2E, the access node may be a UE in communication with a network node to provide a network service. The frame structure 220 includes at least a physical downlink control channel (PDCCH) 222 and a physical downlink shared channel (PDSCH) 224. The PDCCH 222 may be used to provide scheduling signaling. The PDSCH 224 comprises a plurality of symbols each including a plurality of resource elements (REs) which may be used to transmit the signal belonging to (or associated with) the traffic type. In particular, all or part of REs in the symbols 226(1)-226(3) (generically referred to as symbols 226) are reserved for transmitting a pilot signal in the PDSCH 224. The pilot signal may be pre-defined to uniquely identify the signal associated with the traffic type. For example, to identify traffic or a signal associated with the first traffic type, the network node may use one or more reserved or pre-configured symbols (e.g., 226(1)-226(3)) or REs to transmit a first pilot signal (with predefined or pre-configured pilot sequence and configuration) along with the signal transmission in the PDSCH 224. When any other access node receives or detects the first pilot signal in these reserved or preconfigured symbol(s)/REs, it can determine the traffic type and its attributes based on the detected pilot signal. The attributes may include or indicate a channel access priority of the first traffic type or a required channel quality requirement of the first traffic type. In addition, the attributes may further indicate that the priority of the first traffic type that can be higher than a priority of a second traffic type for the traffic transmission. In some examples, the first pilot signal (corresponding to the first traffic type) and at least one signal belonging to the first traffic may be transmitted concurrently in the PDSCH 224. As the first pilot signal is transmitted in the PDSCH 224, the first pilot signal in the PDSCH 224 may be detected by the other access nodes for identifying the traffic type and traffic attributes. In addition, the first pilot signal may be received by the access node for channel estimation on signal demodulation.

FIG. 2F demonstrates a frame structure 230 where the access node transmits at least one pilot signal associated with a traffic type in a UL direction. The frame structure 230 comprises at least a physical uplink shared channel (PUSCH) 232. The PUSCH 232 incorporates a plurality of symbols each including a plurality of REs. As presented in FIG. 2F, the access node may use one or more of the reserved or pre-configured symbols 236(1)-(4) (generically referred to as symbol 236) and REs to transmit a preconfigured/predefined pilot signal along with a signal belonging to a traffic type over a channel (e.g., the first or second channel). The preconfigured/predefined pilot signal can be used to uniquely identify the traffic type.

It is noted that although pilot signal(s) corresponding to a single traffic type may be transmitted by using one or a plurality of symbols on either the PDSCH 224 or the PUSCH 232, it is only illustrative and is not intended to be limiting. In other examples, the number of symbols used for transmitting pilot signal(s) corresponding to a single traffic type may be variable. In some applications, a pilot signal identifying a traffic type may be transmitted in any traffic channel along with the traffic associated with the traffic type. In some examples, the pilot signals may be generated or selected from a pilot signal pool with known pilot sequences. Moreover, the pilot signal may be a reference signal (RS) or a demodulation reference signal (DMRS). The first traffic type 206 may be indicated by a first pilot signal denoted RS_1. In some examples, a first signal (belonging to the first traffic type) and the first pilot signal RS_1 may be transmitted concurrently, such as in the PDSCH 224 of FIG. 2E or the PUSCH 232 of FIG. 2F. The second traffic type 208 may be indicated by a second pilot signal denoted RS_2, and a second signal belonging to the second traffic type may be transmitted along with the second pilot signal RS_2 (e.g., in the PDSCH 224 or the PUSCH 232). For example, when the access node attempting to transmit a second traffic type over the second channel detects the first pilot signal of RS_1 used by traffic currently present in the second channel 204, it is determined that the first traffic type exists in the second channel 204 based on the detected first pilot signal RS_1. It means that a transmission belonging to the first traffic type 206 is currently occupying the second channel 204 by some other access node. Thus, the access node may combine this information with detected energy in the second channel to determine whether the attempt to transmit the second signal (belonging to the second traffic type) over the second channel 204 is allowed. In the case that the first pilot signal RS_1 is detected in the second channel, if the energy detection is above the first EDT, the attempt of transmitting the second signal over the second channel may be denied or not allowed in order to prevent degrading the QoS of the first traffic type 206 that is present in the second channel 204.

In some examples, the first and second pilot signals (e.g., RS_1 and RS_2) indicating different traffic types may be pre-defined or pre-configured to be orthogonal with respect to each other. For example, each pilot signal may be defined by a pseudo-random sequence, such as Zadoff-Chu (ZC) sequence, or by a Binary Phase-shift Keying (BPSK) or Quadrature Phase-shift Keying (QPSK) modulated signal. The pilot signals may be defined to be orthogonal with respect to each other using a portion of frequency resources and/or one or more symbols in each of one or more transmission slots over the spectrum. For examples, the PDSCH 224 in FIG. 2E or the PUSCH 232 in FIG. 2F may reserve or be configured with a different respective number of symbols for each pilot signal (e.g., RS_1 or RS_2). In some examples, the access node may be configured to use the first and second pilot signals for transmitting the signals corresponding to the first and second traffic types through configuration signaling, which may be performed semi-statically via RRC signaling or dynamically via DCI signaling, or/and via MAC CE signaling.

Referring back to FIG. 1 again, consider the example that a network service (e.g., belonging to the first traffic type 206 or the second traffic type 208) is established between a BS (e.g., T-TRP 170a) and a UE (e.g., ED 110a), and the ED 110a is the access node disclosed herein. The T-TRP 170a may update or adjust channel resource allocation (e.g., including time and/or frequency resources) of the spectrum 200, and send one or more configuration signals to the ED 110a dynamically (e.g., via DCI signaling) or semi-statically (e.g., via RRC signaling) or via (MAC-CE) signaling or a combination of thereof. In some examples, the channel resource allocation of the first channel 202 and second channel 204 may be variable based on at least one of frequency bands, channel bandwidths, and numerologies (e.g., numbers to indicate different types of sub-carrier spacing, and cyclic prefix (CP)) of the spectrum. In some examples, after the T-TRP 170a performs the channel configuration or updates the channel resource allocation, the T-TRP 170a may unicast the channel resource allocation to the ED 110a to inform the ED 110a which channels (e.g., a spectrum including 4 first channels and 16 second channels) are available for use. In other examples, the T-TRP 170a may broadcast the channel resource allocation. In some examples, each of the first channel 202 and second channel 204 of the spectrum may be a sub-channel of a system channel bandwidth in a frequency band. For examples, in a 6 GHZ frequency band where the system channel bandwidth is 20 MHz, a bandwidth of each sub-channel is 1 MHz. Thus, the spectrum in the 20 MHz system channel bandwidth may include 20 sub-channels in total, which may each be configured to be a first channel 202 (for carrying the first traffic type) or a second channel 204 (for carrying the second traffic type). In some examples, the allocation of channel type may be performed evenly (i.e., the sub-channels are evenly divided into the different channel types). For example, the 20 sub-channels may be configured to include 10 first channels 202 and 10 second channels 204. In other examples, the allocation of the sub-channels among different channel types may be adjusted in accordance with the channel resource allocation. It is noted that although one first channel 202 and one second channel 204 is discussed in the example of FIG. 2A, it is only for the purposed of illustration. In other examples, the respective number of the first channel 202 and second channel 204 may be more than one. In some other examples, the first channel(s) 202 configured for transmission of the first traffic type may include the PDCCHs.

The network configuration on channel(s) for UE traffic transmissions can be per UE based (e.g., the configured channel(s) for one UE to transmit data/traffic of any traffic types). Alternatively, the network configuration on channel(s) for UE traffic transmissions may be per traffic type based. That is, different traffic types may be configured to be associated with different channels for one UE. In some examples, the T-TRP 170a may perform the channel resource allocation for transmission implemented by the ED 110a based on the number of EDs that request channel resources. For example, if there are three EDs (including the ED 110a) in total requiring channel resources to perform transmissions, regardless of traffic types performed by the ED 110a, the T-TRP 170a may allocate one third of the total channel resources to the ED 110a for the transmission. In other examples, the T-TRP 170a may allocate the channel resources for the ED 110a based on traffic types implemented by the ED 110a. For example, the ED 110a attempts to transmit a signal with a higher priority traffic type (with high QoS requirement), the T-TRP 170a may allocate as many channel resources as possible to the ED 110a because the higher priority traffic type needs to be performed at the ED 110a.

It is noted that although an example spectrum including two types (associated with two different EDTs) of channels is illustrated and discussed in the example of FIG. 2A, this is only illustrative and is not intended to be limiting. In other examples, the example spectrum may include more than two types of channels. For example, a third channel may be associated with a third EDT which is even lower than the first EDT. The third channel may be configured for transmission of a third traffic type having a priority (denoted as P3) higher than the first priority (denoted as P1) that in turn is higher than the second priority (denoted as P2). That is, P3>P1>P2. The third EDT may be defined to be stricter than the first EDT (which in turn is stricter than the second EDT), such that signals can be transmitted over the third channel with higher quality.

An example of how transmission of the third traffic type over a spectrum may be performed is now discussed. In the case where an access node is configured for cross-channel access, the method of FIGS. 2C and 2D may be adapted to ensure that the QoS of the third traffic type is sufficiently high regardless of the channel being used to transmit the third traffic type. For example, for transmitting a third signal belonging to the third traffic type (e.g., where the third traffic type has a third priority that is higher than the first priority, i.e., P3>P1>P2), the access node may first attempt to access the third channel (which is configured to transmit the third traffic type) to transmit the third signal. The process of attempting to access the third channel is similar to the steps 2122, 2124, and 2146 of FIG. 2C except that it is the energy of the third channel to be detected, and the third EDT (lower than the first EDT) is used in the steps 2122, 2124, and 2146 as a threshold for determining whether to access the third channel. If the third channel is busy, and the access node is enabled for cross-channel access, the access node may then attempt to access other channels (which are channel types other than the third channel type) over the spectrum one by one until there is a channel found over the spectrum that has a detected energy which is less than the third EDT. The attempt to access other channel types (e.g., the first channel 202 or the second channel 208) is implemented in a similar manner to steps 2122-2124 except the first EDT in steps 2122-2124 is replaced with the third EDT. If none of the channels in the spectrum has detected energy less than the third EDT, after a preconfigured time period expires, the access node may return to step 2122 again.

Referring back to FIG. 2D again, FIG. 2D can be adapted in the case where there is a third traffic type. In the case where the third traffic type (having a highest priority, P3) exists, steps 2142-2154 can be adapted to transmit the lower priority traffic type (e.g., first and second traffic types having second highest priority P1 and lowest priority P2) over a corresponding channel (e.g., the first channel 202 or the second channel 204).

Taking a transmission of the first signal associated with the first traffic type for example, step 2142 is adapted to detect energy in the first channel 202, and the detected energy is compared with the third EDT and/or the first EDT. If the detected energy in the first channel 202 is less than or equal to the third EDT, the first channel 202 is accessed to transmit the first signal belonging to the first traffic type at adapted step 2148. If the detected energy is greater than the third EDT and less than or equal to the first EDT, then step 2146 is adapted to determine if a traffic type having a priority higher than the first priority (i.e., P1) is occupying the first channel. If there exists a traffic type with a higher priority (e.g., P3) in the first channel 202, transmission of the first signal over the first channel is denied at adapted step 2150, in order to prevent the transmissions associated with even higher priority from being adversely affected. If no higher priority exists in the first channel 202, the first channel 202 is accessed to transmit the first signal associated with the first traffic type. If the detected energy in the first channel 202 is greater than the first EDT, the first channel 202 is then determined to be busy. Thus, transmission of the first signal over the first channel 202 is denied at adapted step 2150. In some examples, at adapted steps 2152-2154, optionally, in the case where the first channel 202 cannot be used for the transmission of the first signal of the first traffic type, an attempt to cross-channel access the third channel or the second channel may be performed by comparing the detected energy in the third channel or the second channel to the third EDT.

Thus, in the scenario where more than two traffic types (corresponding to different relative priorities P1, P2, and P3) exist in a spectrum, and cross-channel access is enabled, transmission of a given traffic type (e.g., the first traffic type 206) may involve the access node first detecting energy in a channel and comparing the detected energy with a EDT that is associated with the highest priority traffic (e.g., the third EDT associated with the highest priority third traffic type). If the detected energy is lower than the EDT associated with the highest priority traffic, then the channel can be access to transmit the given traffic type. If the detected energy is higher than the EDT associated with the given traffic type, then the channel has an interference level that is unacceptable for the given traffic type and access to the channel is denied. In the case where the detected energy is lower than the EDT associated with the given traffic type but higher than the EDT associated with the highest priority traffic, the access node performs operations to determine whether there is any traffic in the channel that has a priority higher than the priority of the given traffic type (e.g., based on pilot signals), and the channel is accessed only if there is no traffic type with a priority higher than the priority of the given traffic type.

In the example where the spectrum 200 includes three types of channels configured to transmit three different traffic types (corresponding to three different priorities), it should understood that step 2146 as shown in FIG. 2D may be adapted to check for the presence of any traffic type having a priority higher than the priority of the traffic type of the signal to be transmitted, in order to avoid causing interferences to those higher priority traffic type(s). For example, if attempting to transmit the second traffic type 208 over the second channel 204, step 2146 should check if any signals of the third traffic type or the first traffic type is occupying the second channel 204 to prevent transmission(s) of the first and/or third traffic type present in the second channel from being adversely impacted by the transmission of the second signal associated with the second traffic type.

It is noted that although two or more channel types (e.g., the first, second, third channel) are disclosed herein to correspond two or more respective traffic types (e.g., the first, second, third traffic types) each associated with a different respective EDT (e.g., the first, second, third EDT), this is only illustrative. By way of non-limiting example, in one possible configuration, two or fewer channel types may be used to transmit the two or more different respective traffic types. For examples, the first traffic type and the second traffic type may be configured to be associated with (e.g., transmitted over) the first channel, and the third traffic type may be configured to be associated with the second channel as long as the detected signal energy (e.g., interference level) of the respective channel satisfies the criteria (e.g., detected signal energy less than the first EDT for the first traffic type, or less than the second EDT for the second traffic type, or less than the third EDT for the third traffic type). In some applications where a plurality of access nodes (e.g., UE) provide a network service associated with a same traffic type, the first channel may be designated for some access nodes to provide the network service, and the others may access the second channel to provide the network service such that the channel resources of the spectrum may be utilized with efficiency.

It should be understood that the spectrum disclosed in the present disclosure can be an unlicensed spectrum or a licensed spectrum that is shared among BSs from an identical operator or from different operators. Locations of the BSs can be fixed or adjustable . . . . The spectrum sharing discussed in the present disclosure may be applicable to carrier aggregation (CA) or dual connectivity (DC) techniques. Furthermore, the spectrum sharing discussed in the present disclosure may be applicable to same or different RATs utilized between BSs, such as the T-TRPs 170a-170b or the NT-TRP 172 in the example communication system 100.

FIG. 3 is a block diagram illustrating an example apparatus 300, which may be used to implement the methods and systems disclosed herein. For example, the apparatus 300 may be the access node, for example including BSs and/or UEs. Other apparatuses suitable for implementing the present disclosure may be used, which may include components different from those discussed below. Although FIG. 3 shows a single instance of each component, there may be multiple instances of each component in the apparatus 300.

The apparatus 300 includes at least one processing device 302, such as a processor, a microprocessor, an application-specific integrated circuit (ASIC), a field-programmable gate array (FPGA), a dedicated logic circuitry, or combinations thereof. The apparatus 300 may also include at least one input/output (I/O) interface 304, which may enable interfacing with one or more optional input devices 312 and/or output devices 314. In FIG. 3, the input device(s) 312 (e.g., a keyboard, a mouse, a microphone, a touchscreen, and/or a keypad) and output device(s) 314 (e.g., a display, a speaker and/or a printer) are shown as external to the apparatus 300. In other examples, one or more of the input device(s) 312 and/or the output device(s) 314 may be included as a component of the apparatus 300. In other examples, there may not be any input device(s) 312 and output device(s) 314, in which case the I/O interface 304 may not be needed.

The apparatus 300 includes at least one communications interface 306 supporting at least wireless communications over a wireless link. As will be discussed above, in the case where the apparatus 300 embodies an access node, there may be one or more communications interfaces 306 supporting RATs (e.g., 5G NR (New Radio)). The apparatus 300 includes one or more transceiver antennas 316. The antennas 316 may act together as an antenna array, in which case each antenna 316 may be referred to as an antenna element or radiating element of the antenna array. An antenna array may receive signals that are used for energy detection or spectrum sensing, and then transmit a signal belonging to a respective traffic type over a selectively accessed channel of a spectrum.

The apparatus 300 includes at least one memory 308, which may include a volatile or non-volatile memory (e.g., a flash memory, a random access memory (RAM), and/or a read-only memory (ROM)). The non-transitory memory 308 may store instructions (e.g., in the form of software modules) for execution by the processing device 302, such as to carry out the methods described in the present disclosure. In some applications, the memory 308 may store the pre-defined or pre-configured at least first and second EDTs that are used to perform energy detection, as discussed above. The memory 308 may include other software instructions, such as for implementing an operating system and other applications/functions. In some examples, one or more data sets and/or module(s) may be provided by an external memory (e.g., an external drive in wired or wireless communication with the apparatus 300) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

The present disclosure provides certain example algorithms and calculations for implementing examples of the disclosed methods and systems. However, the present disclosure is not bound by any particular algorithm or calculation. Although the present disclosure describes methods and processes with steps in a certain order, one or more steps of the methods and processes may be omitted or altered as appropriate. One or more steps may take place in an order other than that in which they are described, as appropriate.

A person of ordinary skill in the art may be aware that, in combination with the examples described in the embodiments disclosed in this disclosure, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this disclosure.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

It should be understood that the disclosed systems and methods may be implemented in other manners. The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments. In addition, functional units in the embodiments of this application may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this disclosure essentially, or the part contributing to the prior art, or some of the technical solutions may be implemented in a form of a software product. The software product is stored in a storage medium, and includes several instructions for instructing a computer device (which may be a personal computer, a server, or a network device) to perform all or some of the steps of the methods described in the embodiments of this application. The foregoing storage medium includes any medium that can store program code, such as a universal serial bus (USB) flash drive, a removable hard disk, a read-only memory (ROM), a random-access memory (RAM), a magnetic disk, or an optical disc, among others.

The foregoing descriptions are merely specific implementations of this application, but are not intended to limit the protection scope of this disclosure. Any variation or replacement readily figured out by a person skilled in the art within the technical scope disclosed in this disclosure shall fall within the protection scope of this disclosure.

1. A method, at an access node, for sharing a spectrum, comprising:
determining signal energy in a channel of the spectrum by the access node, wherein the channel is one of at least two channels including a first channel and a second channel, the first channel being associated with a first energy detection threshold (EDT), and the second channel being associated with a second EDT that is different from the first EDT; and
transmitting a signal belonging to a traffic type over the channel of the spectrum in response to the determined signal energy satisfying a criteria related to the first EDT or the second EDT.

2. The method of claim 1, wherein the traffic type is one of at least two traffic types including a first traffic type and a second traffic type, the first traffic type having a higher quality of service (QoS) requirement than the second traffic type.

3. The method of claim 1, wherein the first EDT is different from the second EDT in that the first EDT is less than the second EDT.

4. The method of claim 2, wherein the first channel is configured for the first traffic type, and the second channel is configured for the second traffic type.

5. The method of claim 1, wherein determining signal energy in the channel of the spectrum comprises:
performing spectrum sensing to detect signal energy in the first channel or the second channel.

6. The method of claim 1, wherein the criteria related to the first EDT or the second EDT comprises the determined signal energy in the first channel being below the first EDT or the determined signal energy in the second channel being below the second EDT.

7. The method of claim 1, the method further comprising:
determining that the signal belonging to the traffic type is to be transmitted prior to determining signal energy in the channel of the spectrum.

8. The method of claim 1, the method further comprising:
transmitting at least one pilot signal along with the signal over the channel of the spectrum, wherein each of the at least one pilot signal indicates the traffic type of the signal.

9. The method of claim 8, wherein each of the at least one pilot signal is a reference signal or a demodulation reference signal (DMRS), which is pre-defined or preconfigured.

10. The method of claim 1, the method further comprising:
receiving at least one configuration signal to provide configurations for sharing the spectrum, each configuration signal being received via Radio Resource Control (RRC) signalling, Downlink Control Information (DCI) signalling, or Medium Access Control-Control Element (MAC-CE) signalling.

11. The method of claim 1, wherein determining signal energy in the channel of the spectrum comprises:
detecting energy in the first channel; and
detecting energy in the second channel in response to the detected energy in the first channel being greater than the first EDT;
wherein transmitting the signal belonging to the traffic type over the channel comprises:
transmitting the signal belonging to the traffic type over the second channel in response to the detected energy in the second channel being less than or equal to the first EDT.

12. The method of claim 1, wherein transmitting the signal belonging to the traffic type further comprising:
determining a channel occupancy period (COP) based on the traffic type; and
transmitting the signal belonging to the traffic type over the channel of the spectrum within the COP.

13. An access node comprising:
a processor in communication with a storage, wherein the processor is configured to execute the instructions to cause the access node to:
determine signal energy in a channel of the spectrum by the access node, wherein the channel is one of at least two channels including a first channel and a second channel, the first channel being associated with a first energy detection threshold (EDT), and the second channel being associated with a second EDT that is different from the first EDT; and
transmit a signal belonging to a traffic type over the channel of the spectrum in response to the determined signal energy satisfying a criteria related to the first EDT or the second EDT.

14. The access node of claim 13, wherein the traffic type is one of at least two traffic types including a first traffic type and a second traffic type, the first traffic type having a higher Quality of Service (QOS) requirement than the second traffic type.

15. The access node of claim 13, wherein the first EDT is different from the second EDT in that the first EDT is less than the second EDT.

16. The access node of claim 14, wherein the first channel is configured for the first traffic type, and the second channel is configured for the second traffic type.

17. The access node of claim 13, wherein the processor is configured to execute the instructions to determine signal energy in the channel of the spectrum by:
performing spectrum sensing to detect signal energy in the first channel or the second channel.

18. The access node of claim 13, wherein the criteria related to the first EDT or the second EDT comprises the determined signal energy in the first channel being below the first EDT or the determined signal energy in the second channel being below the second EDT.

19. The access node of claim 13, wherein the processor is further configured to execute the instructions to:
determine that the signal belonging to the traffic type is to be transmitted prior to determining signal energy in the channel of the spectrum.

20. A non-transitory computer readable medium storing instructions which, when executed by a processor, cause the processor to:
determine signal energy in a channel of the spectrum by an access node, wherein the channel is one of at least two channels including a first channel and a second channel, the first channel being associated with a first energy detection threshold (EDT), and the second channel being associated with a second EDT that is different from the first EDT; and
transmit a signal belonging to a traffic type over the channel of the spectrum in response to the determined signal energy satisfying a criteria related to the first EDT or the second EDT.
